(19) United States
(12) Patent Application Publication
(10) Pub. No.: US 2005/0073824 A1
(43) Pub. Date: Apr. 7, 2005

(54) Thin lighting panel with multiple visible regions

(76) Inventor: Heng Sheng Kuo, Taipei (TW)

Correspondence Address: HENG SHENG KUO, P. O. BOX 26-757, TAIPEI, TW

(21) Appl. No.: 10/681,807

(22) Filed: Oct. 6, 2003

(51) Int. Cl. H04M 1/22

(52) U.S. Cl. 362/24

(57) ABSTRACT

A thin lighting panel with multiple visible regions has a thin plate with a thickness less than 2 mm, at least one lighting member disposed on at least one edge of the thin plate, and a plurality of patterned regions discontinuously distributed on the thin plate for emitting light to meet particular requirements.

### BACKGROUND OF THE INVENTION

1. Field of the Invention

The present invention relates to a thin lighting panel with multiple visible regions. More particularly, the present invention relates to a thin lighting panel with a simple structure.

2. Background of the Invention

Referring to FIG. 1, the conventional cell phone 1a includes a body 10a, a cover 11a corresponding to the body 10a, and a plurality of LEDs (Light Emitting Diode) 2a disposed on the body 10a. The cover 11a has a plurality of operating keys 111a arranged thereon and the LEDs emit light that transmits through the cover 11a for easy recognition and manipulation of the operating keys 111a by users.

In the conventional cell phone 1a mentioned above the LEDs 2a light the operating keys 111a for recognition. As the display region increases, as when applied in phones, keyboards and notebooks, the LEDs 2a increase in number and disobey the trends towards light-weight, small and power conserving devices.

### SUMMARY OF INVENTION

The object of the invention is therefore to specify a thin lighting panel with multiple visible regions, to emit light to meet predetermined requirements of a plurality of discontinuously visible regions.

Another object of the invention is therefore to specify a thin lighting panel with multiple visible regions with size small, light weight and low power consumption.

According to the invention, this object is achieved by a thin lighting panel with multiple visible regions, includes a thin plate having a thickness less than 2 mm, at least one lighting member disposed on at least one edge of the thin plate, and a plurality of patterned regions discontinuously distributed on the thin plate.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a conventional cell phone;

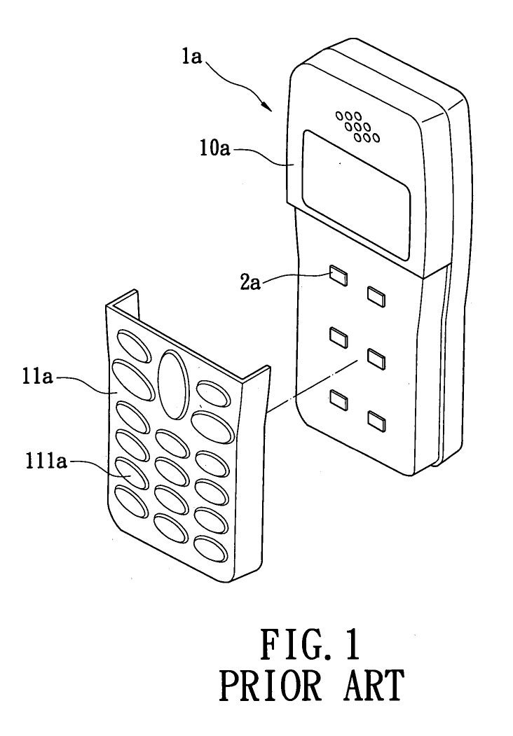

FIG. 2 is a perspective view of the present invention; and

FIG. 3 is an enlarged view of the present invention.

### DETAILED DESCRIPTION OF THE EMBODIMENTS

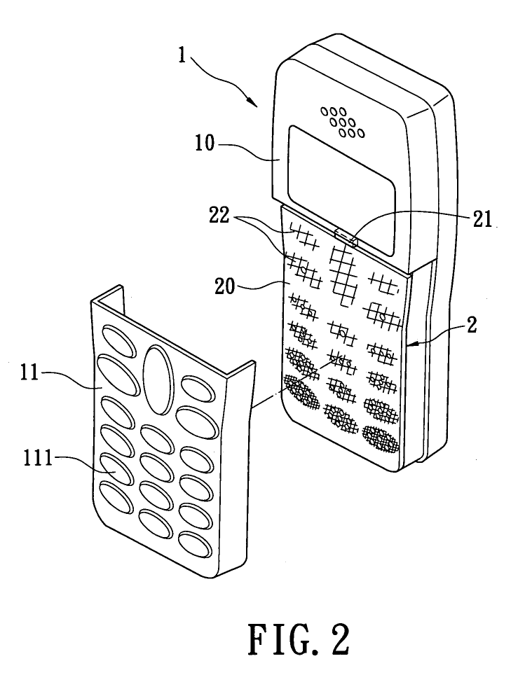

Referring to FIG. 2, the present invention provides a thin lighting panel 2 with multiple visible regions, and is applied to a display device 1. The display device 1 has a body 10 and a cover 11 relative to the body 10. The thin lighting panel 2 includes a thin plate 20 having a thickness less than 2 mm, at least one kind of lighting members 21 disposed on at least one edge of the thin plate 20, a plurality of patterned regions 22 discontinuously distributed on the thin plate and 20. The thickness less than 2 mm achieves the objects of size small and light weight. The thin plate 20 has a front edge, a rear edge, and two side edges. Each patterned regions 22 has at least one kind of patterns including a convex, a concave, or a textured pattern. The lighting members 21 include a LED (Light Emitting Diode) or an OLED (Organic Light Emitting Diode). Moreover, the present invention needs merely one lighting member 21 to make patterned regions 22 lighted and visible, for a cheaper and power conserving device.

The conventional guidelight uses various dots spread on a plate of the conventional guidelight as a result of destructions of the total internal reflection within the plate to provide a uniform lighting emitted from a surface of the plate.

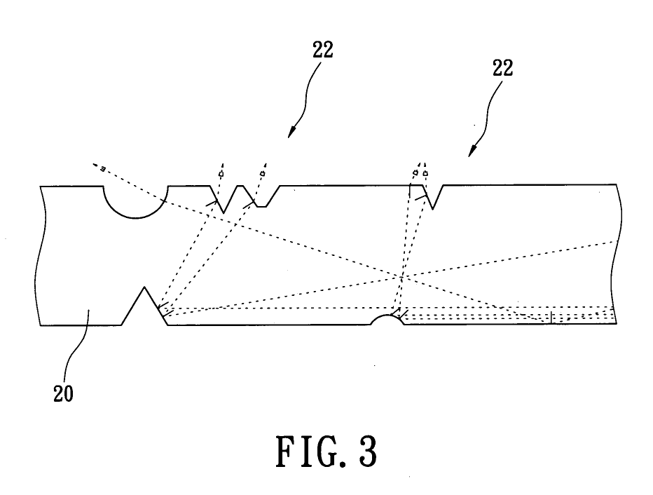

With respect to FIG. 3, the present invention can meet the practice requirements of guiding the light emitted from the lighting member 21 through multiple predetermined regions of the thin plate 20. First, the light is locked within the thin plate 20 because of the total internal reflection, and the thin plate 20 then is a dark object. Second, the thin plate 20 includes a plurality of predetermined regions each having a plurality of patterns; the light is then guided and transmitted through out of the thin plate 20 from the predetermined regions by ways of reflection and refraction. Third, users look at the thin plate 20 from the outside thereof and can easily recognize locations of the regions.

If there is a need to evenly emit the light to provide a high uniformity thereof, the patterned regions 22 should have a first part formed adjacent to the lighting member 21, including the patterns distantly arranged, and a second part formed remote from the lighting member 21, including the patterns closely arranged. Alternatively, the patterned regions 22 can have a first part with small patterns and a second part with large patterns.

In addition, the display device 1 has a plurality of display regions arranged on a cover 11 thereof, and the display regions respectively correspond to the patterned regions 22. Each display regions has at least one operating keypress 111 disposed thereon and relative to the signs, words, or designs with predetermined meanings. Referring to FIG. 2, the display device 1 is a cell phone, the operating keypress 111 is easily recognized and manipulated because of the light emitted from the patterned regions 22 each relating to the operating keypress 111.

As embodiment mentioned above, the display device 1 not only includes cell phones, but also notebooks, telephones, keyboards, PDAs (Pal Digital Assistant), and IA systems (Information Application system).

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A thin lighting panel with multiple visible regions, adopted for a display device and comprising:
a thin plate having a thickness less than 2 mm;
at least one kind of lighting member disposed on at least one edge of the thin plate, wherein the thin plate includes a front edge, a rear edge, and two side edges; and
a plurality of patterned regions separately distributed on the thin plate.

2. The thin lighting panel as the claim 1, wherein the lighting member is a LED (Light Emitting Diode).

3. The thin lighting panel as the claim 1, wherein the lighting member is an OLED (Organic Light Emitting Diode).

4. The thin lighting panel as the claim 1, wherein each patterned region includes at least one kind of pattern.

5. The thin lighting panel as the claim 4, wherein the patterns include a convex, a concave, or a textured pattern.

6. The thin lighting panel as the claim 4, wherein the patterned regions include a first part formed adjacent to the lighting member, including patterns distantly arranged, and a second part formed remote from the lighting member, including patterns closely arranged.

7. The thin lighting panel as the claim 4, wherein the patterned regions include a first part formed adjacent to the lighting member, including small patterns; and a second part formed remote from the lighting member, including large patterns.

8. The thin lighting panel as the claim 1, wherein the display device has a plurality of display regions arranged on a cover thereof, and the display regions respectively correspond to the patterned regions.

9. The thin lighting panel as the claim 8, wherein the display regions respectively include signs, words, or designs with predetermined meanings.

10. The thin lighting panel as the claim 9, wherein each display region includes at least one operating keypress disposed thereon and relative to the signs, words, or designs.
